(19) United States
(12) Patent Application Publication
(10) Pub. No.: US 2007/0097453 A1
(43) Pub. Date: May 3, 2007

(54) Image forming device

(76) Inventor: Shigeki Kimura, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/259,150

(22) Filed: Oct. 27, 2005

(51) Int. Cl. H04N 1/04

(52) U.S. Cl. 358/474

(57) ABSTRACT

The present invention comprises a first means for, if a key input occurs while the audio guide mode is set, determining whether or not a most recently operated key is identical to a previously operated key, a third means for, if the first means determines that the most recently operated key is identical to the previously operated key, determining whether or not the time between when the key had been previously operated and when the key was most recently operated (hereinafter referred to as the operation interval) is within a predetermined time, and a fifth means for validating the most recent key input if the third means determines that the operation interval is within the predetermined time.

### FIELD OF THE INVENTION

This invention relates to an image forming device system such as a multi-function machine comprising a fax function and the like in addition to a copier function.

### BACKGROUND INFORMATION

Image forming devices are developed, comprising a function that causes the operation image not to change even if a job interruption button or the like is mistakenly operated when displaying of an operation image that is large and easy for a user with weak vision so see (enlarged display mode). Note that this device is also known to provide operation guidance by voice if the user has selected audio guide in the enlarged display mode.

In the above conventional example, the job interruption button is disabled during the enlarged display mode so as not to perform work based on a mistaken operation by a user with weak vision. However, as a result, job interruption by others is prohibited during the enlarged display mode.

An object of this invention is to provide an image forming device capable of preventing mistaken operation, while keeping the functions inherent in the device available.

### SUMMARY OF THE INVENTION

According to the invention as recited in Claim 1, an image forming device provided with an audio guide mode and comprising a function for, when the audio guide mode has been set, performing audio guidance for the name or the like of an operated key, comprises: a first means for, if a key input occurs while the audio guide mode is set, determining whether or not a most recently operated key is identical to a previously operated key; a second means for, if the first means determines that the most recently operated key is different from the previously operated key, performing audio guidance for the most recently operated key while at the same time storing the most recently operated key as the previously operated key and then switching to a key input standby state; a third means for, if the first means determines that the most recently operated key is identical to the previously operated key, determining whether or not the time between when the key had been previously operated and when the key was most recently operated (hereinafter referred to as the operation interval) is within a predetermined time; a fourth means for, if the third means determines that the operation interval is not within the predetermined time, performing audio guidance for the most recently operated key while at the same time storing the most recently operated key as the previously operated key and then switching to the key input standby state; and a fifth means for validating the most recent key input if the third means determines that the operation interval is within the predetermined time.

According to the invention as recited in Claim 2, an image forming device provided with an audio guide mode and comprising a function for, when the audio guide mode has been set, performing audio guidance for the name or the like of an operated key, comprises: a first means for, if a key input occurs while the audio guide mode is set, determining whether or not a most recently operated key is identical to a previously operated key, a second means for, if the first means determines that the most recently operated key is different from the previously operated key, performing audio guidance for the most recently operated key while at the same time storing the most recently operated key as the previously operated key and then switching to a key input standby state; a third means for, if the first means determines that the most recently operated key is identical to the previously operated key, determining whether or not the time between when the key had been previously operated and when the key was most recently operated (hereinafter referred to as the operation interval) is longer than a first predetermined time; a fourth means for, if the third means determines that the operation interval is not longer than the first predetermined time, switching to the key input standby state; a fifth means for, if the third means determines that the operation interval is longer than the first predetermined time, determining whether or not the operation interval is shorter than a second predetermined time for which a longer time than the first predetermined time has been set; a sixth means for, if the fifth means determines that the operation interval is not shorter than the second predetermined time, performing audio guidance for the most recently operated key while at the same time storing the most recently operated key as the previously operated key and then switching to the key input standby state; and a seventh means for validating the most recent key input if the fifth means determines that the operation interval is shorter than the second predetermined time.

According to the invention as recited in Claim 3, an image forming device provided with an enlarged display mode for displaying a large and easy-to-see operation image, comprises: a first means for, if a key input occurs while the enlarged display mode is set, determining whether or not a most recently operated key is identical to a previously operated key; a second means for, if the first means determines that the most recently operated key is different from the previously operated key, storing the most recently operated key as the previously operated key and then switching to a key input standby state; a third means for, if the first means determines that the most recently operated key is identical to the previously operated key, determining whether or not the time between when the key had been previously operated and when the key was most recently operated (hereinafter referred to as the operation interval) is within a predetermined time; a fourth means for, if the third means determines that the operation interval is not within the predetermined time, storing the most recently operated key as the previously operated key and then switching to the key input standby state; and a fifth means for validating the most recent key input if the third means determines that the operation interval is within the predetermined time.

According to the invention as recited in Claim 4, an image forming device provided with an enlarged display mode for displaying a large and easy-to-see operation image, comprises: a first means for, if a key input occurs while the enlarged display mode is set, determining whether or not a most recently operated key is identical to a previously operated key; a second means for, if the first means determines that the most recently operated key is different from the previously operated key, storing the most recently operated key as the previously operated key and then switching to a key input standby state; a third means for, if the first means determines that the most recently operated key is identical to the previously operated key, determining whether or not the time between when the key had been previously operated and when the key was most recently operated (hereinafter referred to as the operation interval) is longer than a first predetermined time; a fourth means for, if the third means determines that the operation interval is not longer than the first predetermined time, switching to the key input standby state; a fifth means for, if the third means determines that the operation interval is longer than the first predetermined time, determining whether or not the operation interval is shorter than a second predetermined time for which a longer time than the first predetermined time has been set; a sixth means for, if the fifth means determines that the operation interval is not shorter than the second predetermined time, storing the most recently operated key as the previously operated key and then switching to the key input standby state; and a seventh means for validating the most recent key input if the fifth means determines that the operation interval is shorter than the second predetermined time.

According to this invention, it is possible to prevent a mistaken operation while keeping the functions inherent in the device available.

### BRIEF DESCRIPTION OF THE DRAWINGS

FIG. 1 is a block diagram showing the constitution of a copier.

FIG. 2 is a flowchart showing the processing procedure when key input occurs.

### DETAILED DESCRIPTION OF THE PREFERRED EMBODIMENTS

Hereinafter, an example of this invention as applied to a copier will be described with reference to the figures.

### Example 1

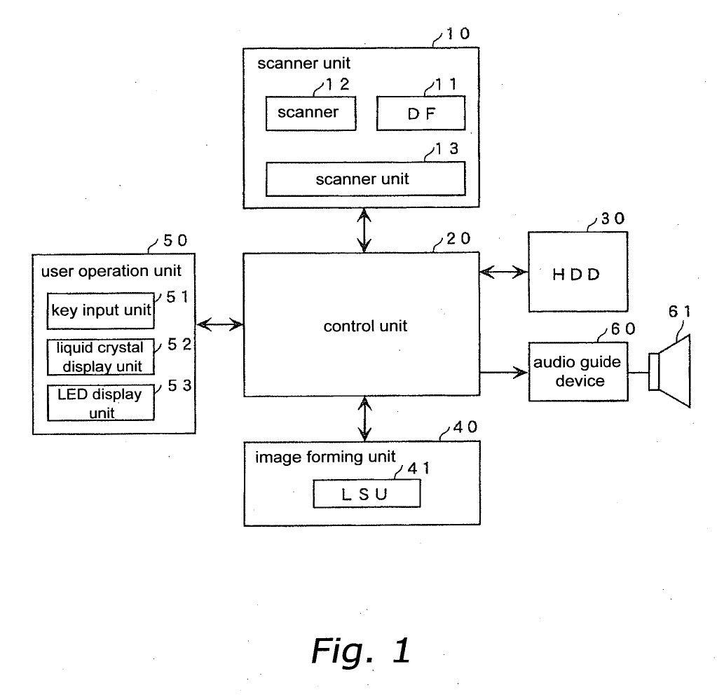

FIG. 1 schematically illustrated the constitution of a digital copier.

The digital copier comprises a scanner unit 10, a control unit 20, a hard disk (HDD) 30, an image forming unit 40, a user operation unit 50 and an audio guide device 60. The scanner unit 10 comprises a document feeding device (DF) 11, a scanner 12 and an image reading CCD 13. The control unit 20 comprises a CPU, a ROM, a RAM and the like.

The image forming unit 40 comprises a laser scan unit (LSU) 41 and an electrostatic copying mechanism comprising a photosensitive drum and the like. The user operation unit 50 comprises a key input unit 51 comprising various keys such as a numeric keypad, a start button and an interrupt button, a liquid crystal display unit 52 comprising a touch panel, and an LED display unit 53. A speaker 61 is connected to the audio guide device 60.

A document transported by the document feeding device (DF) 11 onto a contact glass, not shown, is optically scanned by the scanner 12, and a document image is read by the image reading CCD 13. The document image that has been read by the image reading CCD 13 is stored in the HDD 30 by way of the control unit 20. The image data stored in the HDD 30 is sent to the LSU 41 by way of the control unit 20. The LSU 41 generates, according to the received image data, a laser beam, which is modulated and deviated to form an electrostatic latent image pattern on the photosensitive member.

In this copier, if the audio guide mode has been set, when the user operates a key, guidance for the name, the function or the like, of the key is given by voice, by way of the audio guide device 60 and the speaker 61. It should be noted, however, that this key input is not handled as a valid key input. Thereafter, if the same key is operated again within a given time period, this key input is handled as a valid key input. In other words, a process corresponding to this key input is executed.

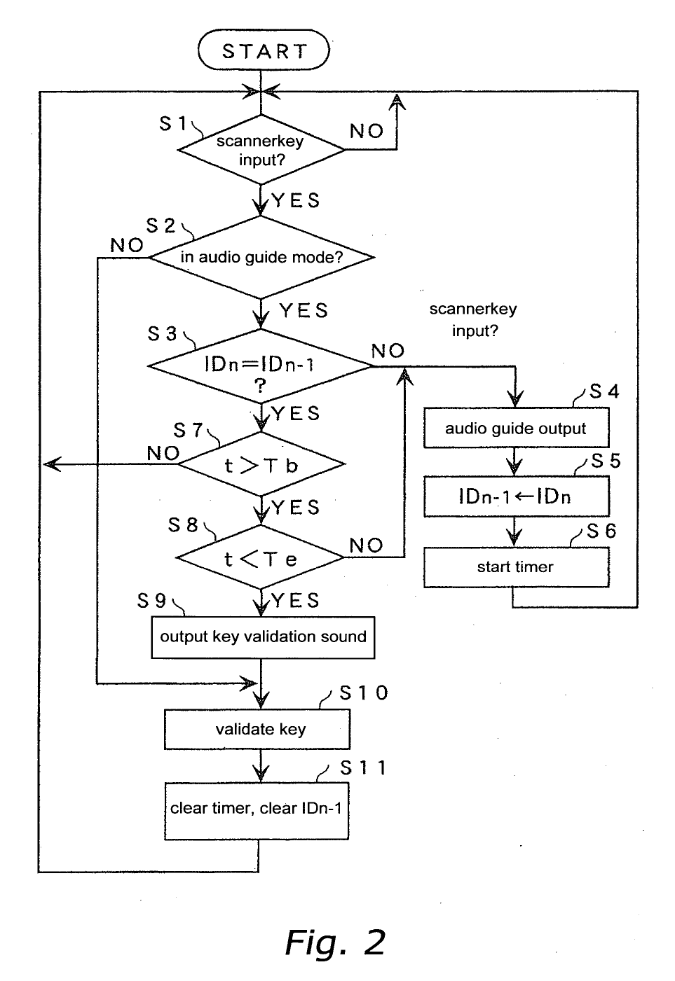

FIG. 2 shows a process procedure when key input occurs.

If a key input occurs by operating a key (step S1), whether or not the audio guide mode has been set is determined (step S2). If the audio guide mode has been set, whether or not the ID of the most recently operated key (IDₙ) and the ID of the previously operated key (IDₙ₋₁) are identical is determined (step S3).

If the ID of the most recently operated key (IDₙ) and the ID of the previously operated key (IDₙ₋₁) are different, audio guidance for the name, function or the like of the most recently operated key (audio guide output) is carried out (step S4), while at the same time, the ID of the most recently operated key (IDₙ) is stored as the ID of the previously operated key (IDₙ₋₁) (step S5). In addition, a timer is started (step S6), whereafter the process returns to step S1 (key input standby state). In addition, when shifting to step S6, if the timer has already been started, the timer is first cleared before being restarted.

In the step S3, if the ID of the most recently operated key (key IDₙ) and the ID of the previously operated key (key IDₙ₋₁) are determined to be identical, whether or not the time t measured by the timer (operation interval) is longer than a predetermined time Tb (t>Tb) is determined (step S7). For instance, the predetermined time Tb is set to 0.5 seconds.

If the time t measured by the timer is not longer than the predetermined time Tb, the process returns to step S1. If the time t measured by the timer is longer than the predetermined time Tb, whether or not the time t measured by the timer is shorter than a predetermined time Te (t<Te) is determined (step S8). For instance, the predetermined time Te is set to 10.0 seconds.

If the time t measured by the timer is not shorter than the predetermined time Te, the process moves on to step S4. If the time t measured by the timer is shorter than the predetermined time Te, that is to say, if a key is operated within a time frame that is longer than a predetermined time Tb and shorter than a predetermined time Te after the same key has been operated, a sound for informing the user that the most recent key input will be handled as the valid key input (key validation sound) is generated (step S9), thereafter, the most recent key input is validated to execute a process corresponding to this key input (step S10). Then, the timer is cleared, while at the same time the content stored as the ID of the previously operated key (key IDₙ₋₁) is cleared (step S11), and then the process returns to step S1.

In the step S2, if the audio guide mode has not been set, the most recent key input is validated to execute a process corresponding to this key input (step S10). Then, the timer is cleared, while at the same time the content stored as the ID of the previously operated key (key IDₙ₋₁) is cleared (step S11), and then the process returns to step S1.

Note that the step S7 may be omitted. In addition, if the audio guide mode has been set, the operation image may be displayed enlarged.

In addition, this invention can also be applied to a copier (image forming device) which is not provided with an audio guide mode but is provided with a mode for displaying a large and easy-to-see operation image (enlarged display mode) for a user with weak vision. In this case, in step S2, whether or not the enlarged display mode has been set is determined, and if the enlarged display mode has been set, the process advances to step S3, while if the enlarged display mode has not been set, the process advances to step S10. In addition, the process of step S4 is omitted. That is to say, if NO in step S3 or if NO in step S8, the process advances to step S5.

What is claimed is:

1. An image forming device provided with an audio guide mode and provided with a function for, when the audio guide mode has been set, performing audio guidance for the name or the like of an operated key, comprising:
a first means for, if a key input occurs while the audio guide mode is set, determining whether or not a most recently operated key is identical to a previously operated key;
a second means for, if the first means determines that the most recently operated key is different from the previously operated key, performing audio guidance for the most recently operated key while at the same time storing the most recently operated key as the previously operated key and then switching to a key input standby state;
a third means for, if the first means determines that the most recently operated key is identical to the previously operated key, determining whether or not the time between when the key had been previously operated and when the key was most recently operated (hereinafter referred to as the operation interval) is within a predetermined time;
a fourth means for, if the third means determines that the operation interval is not within the predetermined time, performing audio guidance for the most recently operated key while at the same time storing the most recently operated key as the previously operated key and then switching to the key input standby state; and
a fifth means for validating the most recent key input if the third means determines that the operation interval is within the predetermined time.

2. An image forming device provided with an audio guide mode and comprising a function for, when the audio guide mode has been set, performing audio guidance for the name or the like of an operated key, comprising:
a first means for, if a key input occurs while the audio guide mode is set, determining whether or not a most recently operated key is identical to a previously operated key;
a second means for, if the first means determines that the most recently operated key is different from the previously operated key, performing audio guidance for the most recently operated key while at the same time storing the most recently operated key as the previously operated key and then switching to a key input standby state;
a third means for, if the first means determines that the most recently operated key is identical to the previously operated key, determining whether or not the time between when the key had been previously operated and when the key was most recently operated (hereinafter referred to as the operation interval) is longer than a first predetermined time;
a fourth means for, if the third means determines that the operation interval is not longer than the first predetermined time, switching to the key input standby state;
a fifth means for, if the third means determines that the operation interval is longer than the first predetermined time, determining whether or not the operation interval is shorter than a second predetermined time for which a longer time than the first predetermined time has been set;
a sixth means for, if the fifth means determines that the operation interval is not shorter than the second predetermined time, performing audio guidance for the most recently operated key while at the same time storing the most recently operated key as the previously operated key and then switching to the key input standby state; and
a seventh means for validating the most recent key input if the fifth means determines that the operation interval is shorter than the second predetermined time.

3. An image forming device provided with an enlarged display mode for displaying a large and easy-to-see operation image, comprising:
a first means for, if a key input occurs while the enlarged display mode is set, determining whether or not a most recently operated key is identical to a previously operated key;
a second means for, if the first means determines that the most recently operated key is different from the previously operated key, storing the most recently operated key as the previously operated key and then switching to a key input standby state;
a third means for, if the first means determines that the most recently operated key is identical to the previously operated key, determining whether or not the time between when the key had been previously operated and when the key was most recently operated (hereinafter referred to as the operation interval) is within a predetermined time;
a fourth means for, if the third means determines that the operation interval is not within the predetermined time, storing the most recently operated key as the previously operated key and then switching to the key input standby state; and
a fifth means for validating the most recent key input if the third means determines that the operation interval is within the predetermined time.

4. An image forming device provided with an enlarged display mode for displaying a large and easy-to-see operation image, comprising:
a first means for, if a key input occurs while the enlarged display mode is set, determining whether or not a most recently operated key is identical to a previously operated key;
a second means for, if the first means determines that the most recently operated key is different from the previously operated key, storing the most recently operated key as the previously operated key and then switching to a key input standby state;
a third means for, if the first means determines that the most recently operated key is identical to the previously operated key, determining whether or not the time between when the key had been previously operated and when the key was most recently operated (hereinafter referred to as the operation interval) is longer than a first predetermined time;
a fourth means for, if the third means determines that the operation interval is not longer than the first predetermined time, switching to the key input standby state;
a fifth means for, if the third means determines that the operation interval is longer than the first predetermined time, determining whether or not the operation interval is shorter than a second predetermined time for which a longer time than the first predetermined time has been set;
a sixth means for, if the fifth means determines that the operation interval is not shorter than the second predetermined time, storing the most recently operated key as the previously operated key and then switching to the key input standby state; and
a seventh means for validating the most recent key input if the fifth means determines that the operation interval is shorter than the second predetermined time.
